(19) United States
(12) Patent Application Publication
(10) Pub. No.: US 2012/0180033 A1
(43) Pub. Date: Jul. 12, 2012

(54) System and Methodology for Autonomous, Value-Centric, Architectural, Software Programming

(76) Inventor: David Amos Brown, Indianapolis, IN (US)

(21) Appl. No.: 13/005,531

(22) Filed: Jan. 12, 2011

(51) Int. Cl. G06F 9/44

(52) U.S. Cl. 717/168

(57) ABSTRACT

A system and methodology that allows the lay public to create, edit, and execute complex software programs by implementing a fundamentally new definition of a software program and creating a programming environment that that leverages the existing knowledge of information manipulation that the vast majority of publicly-educated persons possess.

### FIELD OF INVENTION

The present invention relates in general to providing a means whereby the general public can create software programs without knowledge of any text-based or symbol-based software languages. This methodology focuses in a profound way on utilizing the existing knowledge that the general public already possesses regarding how information is used and manipulated and stands in stark contrast to the current common methodology that requires specialized training to achieve the same proficiency. Therefore, to the lay person, the present invention transforms the computer from a machine that just runs programs to a machine that can also create them.

### BACKGROUND OF THE INVENTION

Since the early 1980's when the Personal Computer (PC) first became commonly accessible to the general public, software engineers have strived to improve the “usability” factor of the PC by making its functionality as intuitive as possible. Most of this effort over the decades since has centered on the user interface with innovations such as the GUI (Graphical User Interface) which made the mouse a common part of the PC experience. This effort toward intuition has been aimed at accommodating all users especially those that have little to no experience or training in computer technology.

The same cannot be said about the programming part of the computer functional equation (hardware+software=information tool.) There have been many software languages developed for the computer starting with punch cards in the 1960's all of which required a significant amount of professional-level training. Training that is geared toward employment-level proficiency. This is true of all of the textual, syntactical programming languages as well as graphical-based languages like “G” (National Instruments Inc. Patent No. 5,291,587) which requires the programmer to understand symbols like op amps and multiplexers etc. that are common in the Electrical Engineering discipline. Most languages not only require knowledge of the language itself but also the software development program that is required to create programs in a given language.

To this day, without the knowledge of a software language, creating a software program is out of reach to the common PC user. This has many negative implications for the user as well as the advancement of information technology in general. Commercial programs are progressively getting bigger and more complicated because the software engineers try to accommodate every functional need of every user. The results of this practice are programs that are time consuming to learn and expensive for businesses to maintain a general level of proficiency. Not only are many contemporary programs for the PC too big and complicated, but they also require an enormous amount of man-hours and expense to create. Today's informational needs are changing rapidly. A business that needs a special application will probably experience a fair amount of informational-needs evolution before the special program is completed.

This is where we are today with computers and software programs. Many people have become proficient at using the computer at some functional level but if you want to do anything innovative or custom in the information world with a computer, you have to have a software engineer or someone trained in software technology to make that innovation or process a reality.

The present invention addresses this problem by providing a methodology and software operating system for creating and running programs that are intuitive to anyone with a modicum of public-level education. This invention will allow the lay public to create programs that can satisfy the informational needs of the vast majority of computer-based processes.

### SUMMARY OF THE INVENTION

The present invention implements a new definition for a software program by providing the fundamental principles of a software architecture and runtime behavior that directly support and enforce said new definition. The implementation of this new “program” definition establishes a new software technology termed: AVCAP (Autonomous Value-Centric Architectural Programming) which encompasses the methodology required to create programs based on said new software technology. The preferred embodiment of said software architecture is an operating system termed: AOS (pronounced “ayose”, AVCAP Operating System) and is required to run programs (AOS Tasks) built using AVCAP technology. AOS operates as a layer of abstraction on top of a hardware operating system such as Windows. AOS Libraries (Servers) and AOS Computers execute AVCAP programs (Tasks). The specific software-language implementation of said software architecture and said software technology is arbitrary. The present invention conveys the fundamental software design criteria and methodology that enables said new software technology which is realizable in any existing software development solution and supported languages.

### BRIEF DESCRIPTION OF THE DRAWINGS

The present invention is described using specific programming examples whose description is supported by the supplied drawings of which below is a brief description.

FIG. 1 shows the elementary model for all programs.

FIG. 2 shows the fractal nature of all Function-Centric programs.

FIG. 3 is the Data-value hierarchy for a Value-Centric Add Function.

FIG. 4 is a block diagram representation of the software architecture for the Value-Centric runtime environment.

FIG. 5 is the Data-value hierarchy associated with a blank Data-value Expression.

FIG. 6 shows an exemplary program Data-value hierarchy after one of its values is converted to a Smart Value.

FIG. 7 shows the programming example of FIG. 6 after Functions have been added to the Expression.

FIG. 8 shows the Data-value hierarchy of a programming example after the initial components have been added.

FIG. 9 shows the example of FIG. 8 after all the necessary Data-values have been converted to Smart Values and is representative of the complete Value-Centric programming example.

FIG. 10 shows the Data-value hierarchy associated with a blank Branching Function used in Expressions.

FIG. 11 shows the Data-value hierarchy associated with an arbitrary software function to illustrate extensibility.

FIG. 12 shows an exemplary Data-value hierarchy of the hardware and software connectivity for a small business.

FIG. 13 shows a partial Data-value hierarchy of a Computer in the Value-Centric environment.

FIG. 14 shows a partial exemplary Data-value hierarchy for a Value-Centric Process.

### DETAILED DESCRIPTION OF THE INVENTION

The current accepted definition of a program is synonymous with a process as follow: Process:

“In computing, a process is an instance of a computer program that is being executed. It contains the program code and its current activity. Depending on the operating system (OS), a process may be made up of multiple threads of execution that execute instructions concurrently.”

Program:

“A sequence of coded instructions that can be inserted into a mechanism (as a computer)”

As can be seen, the current definition of a program is based on the definition of an instruction. An instruction provides information as to a function or functions to perform on the targets of the function. A program is a sequence of instructions each of which completes a desired operation such as assign, update, or transfer one or more data values. It is the fulfillment of a verb/verb-subject relationship. Therefore, software is comprised of two primary entities. The verbs are the defined set of possible functions and the verb subjects are the data values that comprise the function's data needs and data result. Therefore, all programs can be effectively summarized into Data and Functions.

The current accepted definition of a program is based on a Function-Centric concept and is the foundation of literally all the current software running on every computer in the world. It is written in manner that reduces the data values to a secondary entity evidenced by their being buried within the definition of an instruction. It is interesting that a definition could not be found that specifically mentions the Data that is the intended purpose of all programs. Function-Centricity is the creation of a set of software functional tools that are used to complete the operations of a larger program that contains them. So why does the concept of a program revolve around only its functional capability?

A Better Function-Centric Definition

“A sequence of coded instructions that can be inserted into a mechanism (as a computer) for the purpose of manipulating information according to the intentions of a programmer.”

An equally valid definition for a program exists that focuses on the Data.

The Value-Centric Definition of a Software Program:

“A sequence of Data-value updates. Values that have their equivalency and update sequences defined”

A Function-Centric program executes a sequence of sub-functions (programs). A Value-Centric program executes a sequence of individual Value updates. In a Function-Centric program, the intelligence (decision making) is within the sub-functions. In a Value-Centric program, the intelligence is within the individual Values.

Validity of the Value-Centric Approach

Proof of the functional equality of the Value-Centric and Function-Centric definitions of a program can be found by examining a program as it executes in time. Every program is comprised of one or more software sub-functions. Each of these sub-functions is a program itself and an independent software entity that performs a specific informational task. The purpose of dividing a program into sub-functions is to create a set of custom software tools that a programmer can use repeatedly. Dividing a program into smaller sub-functions also assists the process of troubleshooting program execution. Once a sub-function completes its execution, any values it created to perform its task are destroyed. Only those values that have been defined outside of the sub-function still exist and are the intended purpose of the sub-function's usage. These types of values are commonly called global values. The concept of a global value is based on the idea that it survives after the Function that updated it terminates. If these global values were recorded every time one of them changed, a defined pattern of value changes would exist that directly correlate with the defined and repetitive pattern of sub-function execution. If the global values could be programmed to update themselves correctly and in the right sequence, then the sub-functions would not be needed to reproduce the program's behavior. This is the basis of Value-Centricity which states:

“A program whose variable global values correctly evaluate their own equivalency in the correct sequence relative to each other is identical in functionality to a program that uses a set of sub-functions to evaluate the equivalency of those same variable global values.”

The benefits of approaching software design where the variable Values get programmed instead of the Functions are enormous but not without their associated tradeoffs. The purpose of redefining the software program in Value-Centric terms is to approach software programming in a manner that reflects the lay person's understanding of the creation, use, and manipulation of information. To understand this concept more fully, the manner in which humans approach and use information has to be examined beginning with its most elementary concepts.

The Lay Person's Understanding of Information

Human Communication of Information

Information is the raw material of the human intellectual process. It is the means by which actions are decided upon and/or new information is created. If it's cold today I'll wear my coat and I will remember how often I have to wear it. The temperature outside determines the action taken. The human mind executes perhaps trillions of decisions per second storing many results as new information. The human mind is therefore an enormous decision engine fueled by information.

Information can be defined as the state of something such as height or width or brightness at a specific instant in time. Every attribute of everything that exists including things like concepts has an infinite number of states over the span of its existence. Our height changes an infinite number of times over our life but we may only want to record it a few times. Information recorded becomes Data that is to be used for future decisions.

The complexity of the information within the human mind is not a problem until one human wants to share information with another entity or record it externally. Humans have developed types of information and rules for their use to convey information to each other. For all intents and purposes, humans communicate in one of six languages:
1) A general language used in speech and writing for the conveyance of all concepts and information. In written form it is known as Text.
2) A language for the conveyance of quantity information through the use of numbers
3) A language for the conveyance of time information through seconds, hours, days, months, and years.
4) A language for the conveyance of two-state information through the use of true, false, on, off, yes, no, etc.
5) Picture information
6) Sound information

Human Management of Information

The only way that humans manage large quantities of information mentally is to categorize that information (Data) by grouping pieces of information into a hierarchical organization of topics for a given subject matter where the same Data can be organized under more than one hierarchical topic set and subject matter. This is to facilitate the retrieval of Data. Regardless of the set of informational topics used, the organizational structure is always a tree when it pertains to one given subject matter. Books in a library are categorized into types or categorized into author names or a finer granularity of subject matters. They could be categorized by time of publication or numbers of pages. The same books can be organized with different informational criteria but the subject matter is still the books contained in the library. The tree structure is the natural form of the solution for a human that solves the problem of how to maintain a large amount of information and be able to retrieve it when needed. I could categorize everything I know about the Civil War based on the time events happened or organize it under sides in the conflict or political information verses military information. The end result would be an organization that best supports the informational perspective that is most relevant to me or the easiest to remember. But it would still be a tree of information. A tree is a fractal construct in that every branch of the tree is a tree itself. Every branch of the tree has a unique path of branches that define its location relative to the root of the tree. Therefore, all Data contained within a tree structure has a unique address for retrieval. All Data contained within a branch of the tree pertains to the topic of information that the branch is defined by. A tree can be extended without bound.

Human Manipulation of Information

Education is all about receiving information and learning how to use it. In school, we learn about Math functions and English functions etc. We have been trained from the very beginning that there are functions and rules for those functions along with the kind of information those functions work on and the results they produce. This is the basis for the common understanding that educated people have about manipulating information in the languages they use to communicate. Anyone who has graduated from High School has already been introduced to:
Math—how to manipulate numbers
English—how to manipulate words in speech and text
How to express time in speech and text
How to evaluate a logical expression (Philosophy?)

The only one above that might be questionable in training in Logic. The basic rules for logic could be expressed on a single page of text with examples and the reader would understand that True AND False=False and True OR False=True. If this understanding is missing, it can easily be filled unlike Math and English. There is nothing in Logic that is difficult to understand because every human being uses Logic every day of their life without being aware of it. All information processors are Logic-based decision engines.

Another concept that is taught in school that relates to function is form. The knowledge of Data Form is essential to applying function to information. Value, List, and Table are understood by all publicly educated lay persons. For example, addition requires two Values. Sum uses a List of Values. Tables are understood as two dimensional structures of related Data where each column is a specific Type of Data. If the fact that an “Assembly” is any combination of Values, Lists, Tables, and other Assemblies is conveyed to the lay person, we then have a complete domain of Data Forms with which to work with on a common level of understanding.

Human Understanding of Additive Functionality and Building Blocks

Every lay person understands that most “functional” things are made up of other simpler functional things. Most understand for instance that a car is made up of an engine, transmission, and other functional parts. Therefore, if a lay person is presented a set of functional items for manipulating information, he/she inherently assumes that those items can probably be combined to create a new functional “thing” out of those functional items.

A Programming Environment for Lay Programmers

From the previous discussion, we now have a domain of understanding with which to build upon to create a programming environment and methodology that is intuitive to all lay persons with a High School education.

Data Types are confined to:
1) Text
2) Numbers
3) Dates and Times
4) Logic (yes/no, true/false, on/off etc.)
5) Pictures
6) Sounds
7) Binary for things that cannot be described any other way like files for other programs

Data Forms are confined to:
1) Values
2) Lists
3) Tables
4) Assemblies

A set of functions and their descriptions is provided for selection upon which more complex functions can be created. The set of provided functions would naturally cover:
1) Functions for manipulating Text
2) Functions for manipulating Numbers
3) Functions for manipulating Dates and Times
4) Logic Functions

To be compatible with a lay person's understanding of information manipulation, the process of creating a program must be no more complex than:
1) adding functional components to an interface each of which come with a set of supporting values
2) setting those values manually some of which are Addresses of where to get Data during program execution

It goes without saying that the functional components have to be understood as to what they do and how the supporting values play a part in their functionality. The process of finding existing Data or finding Addresses to existing Data for use in value assignments must be straightforward and intuitive.

Fundamentally, this is really not very different than what programmers do in any programming language. Every instruction is either:
declaring a data type and setting its value or assigning where to get its value
declaring a new function and the data it requires and/or the results it returns
referencing an existing function and setting where it gets its data and/or return its results

The disconnect occurs in the use of another language that lay persons do not understand that must be interpreted before a computer can execute the program it was written in.

The Role of Function in a Value-Centric Programming Environment

The concept of Function in programming is innate. Function represents the actions that are performed. All programming distills down to two components—Data and Function. All Functions in the computer require at least one piece of information. If nothing else, “when” to run is information input to all computer Functions (programs). In reality, there is no such thing as a random number which ideally requires no input. Therefore, all Functions in the computer require at least one piece of information.

All Functions in a computer produce a result. That result may be just to move Data from one location to another but it is a result all the same. The Data at the destination location changed. Therefore, all computer Functions perform at least one of the following actions:
1) Create new Data from existing Data
2) Move Data from one location to another

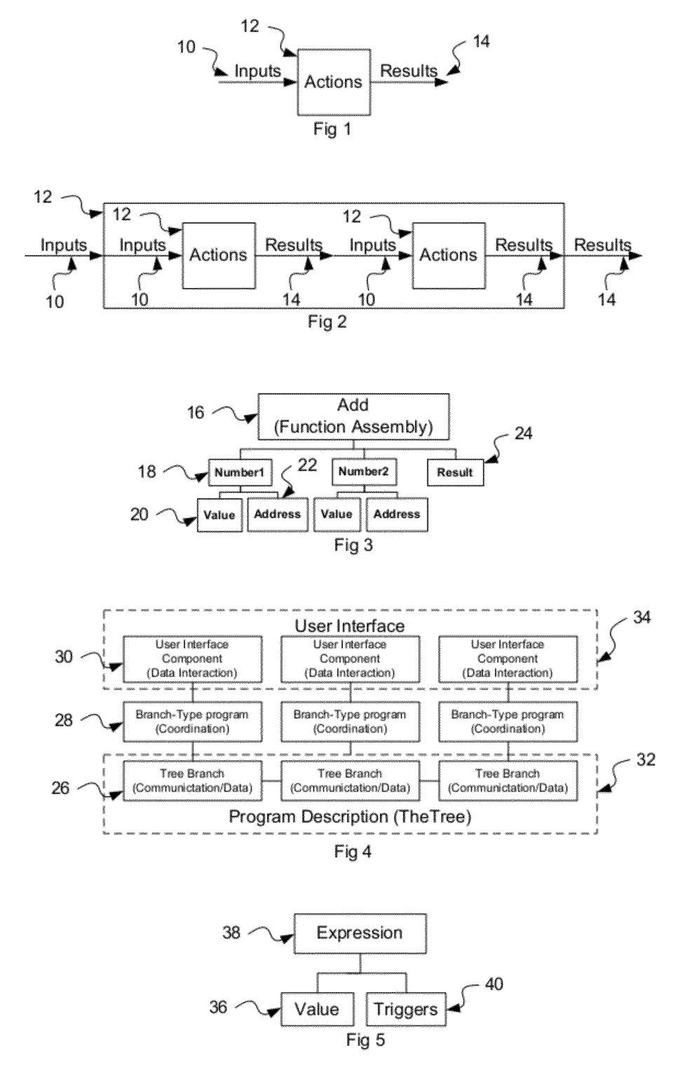

Most Functions do both. FIG. 1 is the elemental model of all programs.

Function-Centric programs are comprised of one or more Functions (mini programs) that serve as available “Tools” to manipulate information. Large commercial programs are comprised of thousands of individual Functions. Programming is primarily the use of existing functionality or the creation of new functionality by building upon existing functionality. Every time a new Function is created it can be made available for future Functions (programs) to use. For any program to exist in the computer, there had to be an initial set of Functions to build upon. For those knowledgeable in the art of software programming, this is understood as the instruction set designed into the architecture of the microprocessor. The most elemental level of programming (Assembly) works directly with these “hard-wired” Functions. All other software languages are built upon these elemental Functions to create higher-order Functions that are more intuitive to programmers.

No matter how many or in what configuration a set of Functions is in, the resulting model is still the same. FIG. 2 illustrates this concept. Regardless of the arrangement or call sequence of a set of Functions, a functional boundary can be drawn around all of them and there would still be Inputs 10, Results 14, and aggregate Actions 12. All programs have a primary purpose, require at least one piece of information, and produce a result that is ultimately required by a human. The result may be driving a machine, but that was the intention of the human who programmed it.

The computer only knows what and how to do anything because a human instructed it to do so. That human used the fundamentals of information manipulation that were learned in public education regardless of whether he/she is professionally trained or not. The concept of “two plus two” never changes regardless of whether it is evaluated within the computer or not. A professional software programmer receives training as to syntax and rules of a given language as well as complex data types and how to get to Functions within an operating system. But when it comes to pure information manipulation, professional and lay programmers operate on the same basic understanding of how information is used and manipulated.

In programming, three things always occur whenever a Function is called upon to perform some Action(s).
1) The input Data is retrieved from locations that were set in the program
2) The Function performs its Actions on the Data
3) The Function's result(s) are stored in locations that were set in the program

As mentioned, sometimes the Function is just to move Data. Many times, the Actions taken include User Actions.

In Function-Centric programs, there is only one copy of any specific Function in the program code. During program execution, one or more copies of a Function can be created and kept unique to perform Actions. When these temporary copies of a Function complete their Actions, all the copies of the Function are destroyed and only the original remains with no Data or results. The results of these temporary Function copies were written to the locations that were specified in the program. If those locations were in other running Functions, then they will be destroyed as well when those Functions complete. Ultimately, there is Data storage for all program results outside of any executing Functions.

For the lack of a definitive term, we will call the Function Results that continue to exist after the Function has been destroyed as “Persisted Values”.

A Persisted Value is a value that continues to exist after the Function that created it is destroyed and is therefore a relative term when talking about a Function's result(s). A Persisted Value relative to one Function may be a temporary value inside another Function.

Databases are a prime example of Persisted Values. Databases hold Persisted Values when referring to the Program(s) that manage their Data. Functions are independent Programs and when the computer is turned off, the Databases and other forms of Persisted Values like files remain.

Persisted Values present an ongoing problem to programmers. Most programmers will attest to the fact that managing Persisted Values in complex programs can be daunting. Most Persisted Values are writeable by more than one Function in the program. Databases (Persisted Values) present a significant problem making sure that Data is correct at all times. Numerous programs writing to the same Database, if not coordinated, can write incorrect or out-dated Data to the same records. The same problem exists for all Persisted Values that can be written to by numerous programmatic entities. The fact is that logistically managing and tracking the Data in Persisted Values (who-wrote-what-when) alone in Function-Centric programs puts programming out of reach of a lay person.

Function-Centric programs result in a nested Function-call structure. Functions use other Functions so using one Function usually results in a number of Functions being used in a nested fashion. Lay persons do not think in terms of nested steps when approaching a task. It is logical to a lay person to perform one independent step at a time to complete a task. Function-Centric programs do not perform tasks in the same sequential manner as lay persons. Training is required to view and manage a procedure that executes in a nested-Function manner.

Shared Persisted Values that can be written to by numerous Functions and the shared nested-Function structure that is characteristic of Function-Centric programs have prevented a solution from being found that could provide programming capability to the lay public.

The Value-Centric Solution

Persisted Values and Data Access

To repeat—to be compatible with a lay person's understanding of information manipulation, the process of creating a program must be no more complex than:
1) adding understood functional components to an interface where each functional component comes with a set of supporting values
2) setting those values manually some of which define where to get needed Data during program execution

If a set of Functions is needed to perform an information-manipulating task, those Functions must be able to be added and run sequentially with no confusion as to what they perform and where they get their Data. If a Function needs to retrieve Data during execution, the process of identifying desired Data during program design has to be simple and intuitive for a lay person to use.

The ultimate solution for the lay person has to solve the problem of shared Persisted Values first. The problem lies with the writing of Persisted Values. It is never a problem to allow any Function to read a value. If Persisted Values cannot be written to by Functions that do not contain them, then Persisted Values must control their own value at all times. Ultimately, Functions must be used to do anything with Data. This implies that whatever Functions are required to evaluate and update a Persisted Value, they must be unique to that value (owned as it were by that Persisted Value).

The Smart Value

Smart Values are Persisted Values that can update themselves and therefore must contain programmatic intelligence to orchestrate whatever Functions must be used to update their values. Functions that were intuitively added by a lay person in a sequential manner. This programmatic intelligence must have exclusive control over the Functions it needs to facilitate the controlled independent sequence of Function execution. For example if an Add Function is needed, that Add Function has to be unique and persist so that subsequent Functions can use its result(s) without the possibility of those results changing before they are needed.

A Smart Value is created in AOS by turning a Value into an Expression that evaluates that Value programmatically. Every value in the system can be converted into an Expression. When a Value like “Customer Name” is added to a program interface, that Value is static and manually filled by the user only. It has no program to update its value. When a Value is turned into a Smart Value, an Expression is added to the tree structure where the Value resides. This Expression is an executable environment of independent sequential Functions that are selected and added by the lay programmer. When editing an Expression, an interface is used that shows all the Functions added. Each one of these Functions is executed in the sequence of order added by the Expression's programmatic intelligence. The process of adding a Function to an interface must also make the Data that Function uses immediately available to the programming environment so the lay person can select its result(s) when the next Function is added. Making the Data immediately available means there is a structure of Data that can be added to that makes it uniquely addressable. A tree structure is the solution. A tree can be added to with no extensible boundary. Everything added to a tree is uniquely addressable just by its location in the tree. If the tree persists throughout program execution, all the Data of every Function is available for reading but not writing by external entities.

An example will clarify. Referring to FIG. 3, a Smart Value needs an Add Function to update itself. The Add Function is available to the lay programmer by selection. An Add Function needs two numbers and a value to store its result if it is to be independent. Independence means that the Add Function can be instructed to update and it can evaluate and hold its own results like storing the results of a Function on a calculator for future use. FIG. 3 shows the Data structure of an Add Function in Value-Centric. As can be seen, the numbers that the Function needs have a placeholder 18 as well as the result 24. To allow the Function to be independent and settable as to value or where to get the value, Address 22 has a placeholder that the lay programmer can set by an assistive tool that enables the selection of existing Data in the environment. If selecting actual Data to fill a Value, Data is returned. If filling an Address Value, an Address is returned. The structure of this Function is a tree and can readily be added to an existing tree. Add is an Assembly as described because it contains two Assemblies and a Value. Number1 18 and Number2 are also Assemblies because they both contain two Values. When this Function executes, the programmatic intelligence of Add 16 requests Data from the locations on the tree specified in Address 18 if Value 20 has not been manually filled by the user. When the Numbers have been updated, the addition operation is completed and the result written to Result 24. This writing process is allowed because Add has “jurisdiction” under the rules of Autonomy and the operating system to write to these values only. Only Add 16 can write to Result 24 or Value 20. Data within the Add Function remains valid until the Add Function is run again.

Making Functions independent solves the second part of the original problem of why a lay programming solution was formerly unattainable. If every Function added to a program is unique and contains the Data values it needs to execute and those values are in a tree structure that can be added to an existing tree, then Functions can be added with no other intellectual task than satisfying that Function's Data needs. This allows the sequential composition of Functions to complete a higher-order Function in the manner that lay persons understand while satisfying operational needs for executing complex programs which will be discussed.

As conveyed, a program can consist of a set of Smart Values (values that can update themselves) that update in the proper sequence to replicate a Function-Centric program that accomplishes the same information-manipulation task. A Smart Value can be constructed intuitively concentrating only on what must occur to update it.

TheTree

TheTree refers to the structure of Data that is the result of adding Values, Lists, Tables, and Assemblies to program interfaces. TheTree is described only through the description of the Data structure of Values, Lists, Tables, and Assemblies along with additional needed information about the Data. The description contains information about what any branch of the tree contains. The Add Function discussed is a system-known type and the root block of the Add Function 16 would identify it as such. If the system-type is known then programmatic intelligence of the appropriate type can be associated with that block when TheTree is constructed for program execution. Therefore the software needed to manipulate a Data Type does not have to be stored when a Value-Centric program is stored. Only the Data structure and associated information about it is needed to reconstruct an AVCAP program.

TheTree is a messaging backbone for the operating system. Every branch and leaf of TheTree can send messages to any other branch or leaf. TheTree is built by applying a description of a tree to a newly added branch. Each new branch builds itself based on the description by adding any included branches and adding programmatic intelligence to itself. The programmatic intelligence manages the values within its jurisdiction and contains an interface item that is used whenever an interface is viewing that branch. Therefore every branch and leaf on TheTree when built for execution contains three programmatic components:
1. A system-message processor and data container
2. An operating system component that manages its jurisdictional values
3. An interface component that allows user interaction with the Data the branch manages

FIG. 4 is a diagram of these three components when TheTree is built for program execution. In the diagram, three branches of TheTree are shown to illustrate connectivity. As shown in FIG. 4, every branch and leaf of TheTree contains three programmatic entities. The messaging system and Data storage are contained within the foundational level of TheTree 26. The User Interface component allows access to the Data on TheTree. The intelligence of the tree branch is contained within a system component 28 that coordinates all software activity between the User Interface 34 and TheTree 32. This system component 28 has jurisdiction to write or read any Data within its designed-in Data-value hierarchy as illustrated in FIG. 3 for the Add Function.

There are two system-types of branches that contain the programmatic intelligence which enables runtime execution. The Task and Expression are the two runtime environments. The domain of these runtime environments is the entire tree branches they comprise. A Task is an independent program that has a user-designed interface. An Expression is a program that executes an ordered sequence of Functions to update a Smart Value and uses an interface specific for building Expressions during the editing/testing process. A general editor interface is used when viewing/editing any other branch on TheTree. Expressions execute on command from the Task programmatic intelligence when it is their turn to update their Smart Value.

Program Execution

As stated in the new definition of a program:

“A sequence of Data-Value updates. Values that have their equivalency and update sequences defined”

To put it another way:

“A sequence of Smart Value updates”

Somewhere in the runtime environment exists the information that defines the sequence. The sequence must be defined by the lay programmer and therefore must be intuitive. This is accomplished by providing a list within every Expression. This list is a list of Addresses within a runtime environment on TheTree. The Addresses determine what Data-value updates the Expression follows when it updates. The lay programmer understands the sequence of updates that must occur to manipulate information. It is intuitive to put Triggers within an Expression that is being designed because those Triggers pertain to only that Expression. A Table of Expression Addresses and their Triggers could be used in the Task but it would not be as intuitive as keeping the Triggers within the Expression that uses them. Therefore, the process of creating an Expression for a Smart Value includes setting the Data-value Addresses that the Expression follows in the update sequence.

A Value-Centric Program Example

The fundamental concepts involved in the creation and execution of AVCAP (Value-Centric) programs has been discussed. An example will more thoroughly convey these concepts.

The following example “builds” a Value-Centric program. The term “Architectural” in AVCAP refers to this process of building a program verses writing a program. The program calculates the payment for a loan. The expression for a loan payment is as follows:

$$MonthlyPayment = ( InterestRate + \frac{InterestRate}{( {( 1 + InterestRate )}^{LoanMonths} ) - 1} ) * LoanAmount \qquad ( 1 )$$

We start with a blank Task which is the interface for programs in AVCAP. From the expression above, we can see that there are four named values: MonthlyPayment, InterestRate, LoanMonths, and LoanAmount. MonthlyPayment is the desired end result of the program. The four values which are all numbers are added to the program interface and assigned their names because these items are either input or output items for the User. A button is added to the interface to run the program. The steps are as follows:
1) A numeric Value Control is added to the Task and named “MonthlyPayment”
2) A numeric Value Control is added to the Task and named “InterestRate”
3) A numeric Value Control is added to the Task and named “LoanMonths”
4) A numeric Value Control is added to the Task and named “LoanAmount
5) A Button Control is added to the Task and named “Run”

At this point, all the Controls added are manual controls meaning they have no programmatic intelligence and have to be filled by the user. MonthlyPayment is a program result which means that it has to be a Smart Value to programmatically evaluate its Data value. To make MonthlyPayment a Smart Value, it needs to have an Expression added. This is accomplished by highlighting the MonthlyPayment Control and pressing a function key. Every Value Control knows how to convert itself into a Smart Value by adding a blank Expression Assembly to TheTree at the location of the Value. Arrow keys are used to traverse TheTree so highlighting a Smart Value and pressing the Right Arrow key opens an interface that views the next level of TheTree. For instance, using an addressing syntax as follows:
[Task] is the root of TheTree in our example
[Task][MonthlyPayment] addresses the Smart Value made out of the MonthlyPayment Value
[Task] [MonthlyPayment] [Expression] is the address of the newly added Expression

Every Expression contains the Data-value hierarchy shown in FIG. 5 before Functions are added to define the Expression's equivalency. Referring to FIG. 5, [Task][MonthlyPayment][Expression][Value] 36 holds the existing value of MonthlyPayment. [Task][MonthlyPayment][Expression][Triggers] 40 is a List used to hold Addresses of Data-values that this Expression will follow to update.

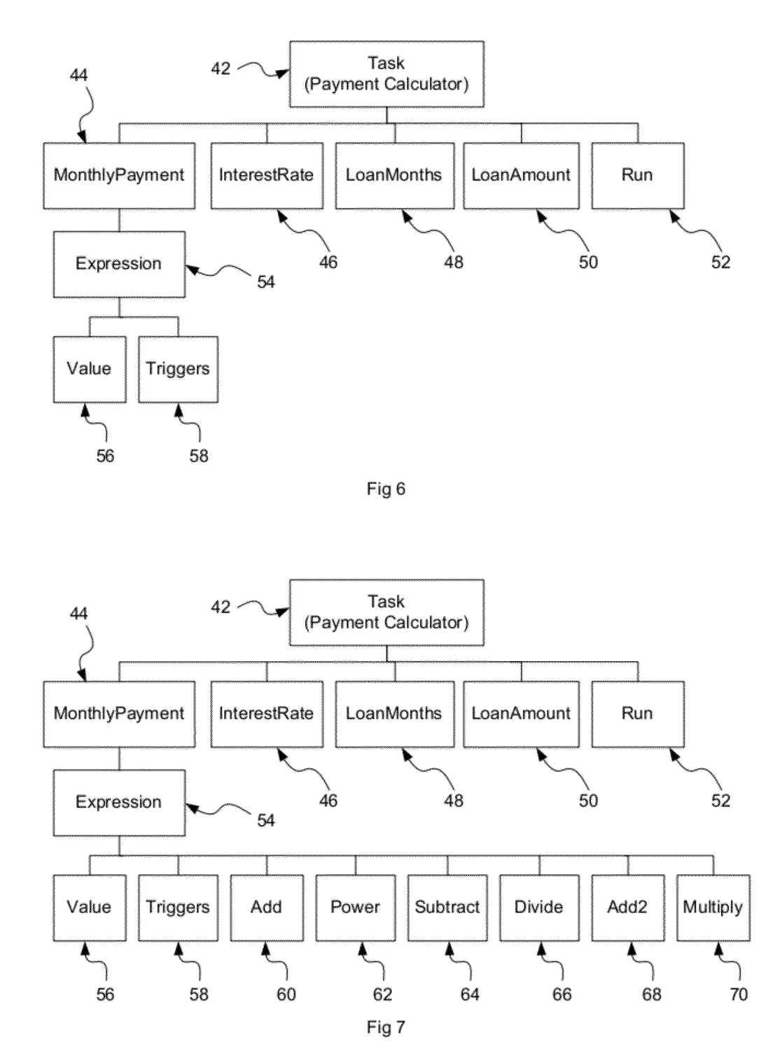

FIG. 6 shows the diagram of TheTree after MonthlyPayment is converted to a Smart Value. MonthlyPayment 44 is still a manual value because its Expression 54 doesn't have any Functions.

The lay programmer has to understand Algebra which is part of a High School education to build this Expression. All equations are evaluated one Function at a time. Everyone who has evaluated an equation by hand understands this. The order of Functions from the MonthlyPayment equation (1) is:
1) Addition
2) Power
3) Subtraction
4) Division
5) Addition
6) Multiplication

These are the Functions and the order that will added to [Task] [MonthlyPayment] [Expression] 54. An Add Function has been shown previously and is typical of all two-input numeric Functions. The Functions added in this example are all two-input Functions and therefore identical in Data structure to the Add Function. FIG. 7 is a diagram of TheTree after the needed Functions are added to [Task][MonthlyPayment][Expression] 54. To save space, the Functions are shown as single blocks even though they all have the structure of the Add Function shown previously.

To complete the Smart Value's design, “[Task][Run]” is added to the Triggers List 58. The program is now ready to run.

The Runtime Engine in [Task] 42 contains four collections for orchestrating Smart Value updates.
1) UpdateNoticesWaiting—a queue to hold updates that have not been processed yet
2) UpdatesExecuting—a queue to assure that all the updates that need to execute complete
3) UpdatesProcessed—a queue to assure that updates do not repeat endlessly (infinite looping)
4) UserUpdatesWaiting—a queue used to hold updates initiated by the user (more on this later)

Below is a step-by-step description of what occurs during program execution.
1) The user enters values for InterestRate 46, LoanMonths 48, and LoanAmount 50
2) The user presses the Run button 52
3) [Task][Run] 52 sends a message upstream to [Task] 42 informing it of the update
4) [Task] 52 adds “[Task][Run]” to the UpdateNoticesWaiting queue and broadcasts a message throughout its branch that [Task][Run] 52 has updated
5) [Task][MonthlyPayment][Expression] 54 receives the updated message and checks its Trigger List
6) [Task][MonthlyPayment][Expression] 54 detects that “[Task][Run]” is on the list and sends back “[Task][MonthlyPayment]” in response to the update message
7) [Task] 42 adds “[Task][MonthlyPayment]” to the UpdatesExecuting queue and removes “[Task][Run]” from the UpdateNoticesWaiting queue
8) [Task] 42 sends out a message to [Task][MonthlyPayment] 42 which gets forwarded to the Expression 54 to commence updating
9) [Task][MonthlyPayment] [Expression] 54 sends a message to the first Function which is Add 60 to commence updating
10) [Task][MonthlyPayment][Expression][Add][Number1][Value] was set to 1 by the lay programmer when added.
   [Task] [MonthlyPayment][Expression][Add][Number2][Address] was set to “[Task][InterestRate]” when added.
   [Task][MonthlyPayment][Expression][Add] 60 sends a message requesting the Data from [Task][InterestRate] and when received, executes the add operation and writes the result to [Task][MonthlyPayment][Expression][Add][Result]
11) [Task][MonthlyPayment][Expression][Add] 60 sends a message upstream informing of the completed update
12) [Task][MonthlyPayment][Expression] 54 receives the message and sends out a message to [Task][MonthlyPayment][Expression][Power]62 to commence updating
13) [Task][MonthlyPayment][Expression][Power][Number1][Address] was set to “[Task][MonthlyPayment][Expression][Add][Result]” when added by the programmer.
   [Task][MonthlyPayment][Expression][Power][Number2][Address] was set to “[Task][LoanMonths]” when added.
   [Task][MonthlyPayment][Expression][Power] 62 retrieves the two pieces of Data and executes the power operation placing the result in [Task][MonthlyPayment][Expression][Power][Result] and informs the Expression
14) [Task][MonthlyPayment][Expression][Subtract][Number1][Address] was set to “[Task][MonthlyPayment][Expression][Power][Result]” when added.
   [Task][MonthlyPayment][Expression][Subtract][Number2][Value] was set to 1 when added.
   [Task][MonthlyPayment][Expression][Subtract] 64 retrieves the Data and places the result of the subtract operation in [Task][MonthlyPayment][Expression][Subtract][Result] and informs the Expression
15) [Task][MonthlyPayment][Expression][Divide][Number1][Address] was set to “[Task][InterestRate]” when added.
   [Task][MonthlyPayment][Expression][Divide][Number2][Address] was set to
   “[Task][MonthlyPayment][Expression][Subtract][Result]” when added.
   [Task][MonthlyPayment][Expression][Divide] 66 retrieves the Data and places the result in [Task][MonthlyPayment][Expression][Divide][Result] and informs the Expression
16) [Task][MonthlyPayment][Expression][Add2][Number1][Address] was set to “[Task][MonthlyPayment][Expression][Divide][Result]” when added.
   [Task][MonthlyPayment][Expression][Add2][Number2][Value] was set to 1 when added.
   [Task][MonthlyPayment][Expression][Add2] 68 retrieves the Data and places the result in [Task][MonthlyPayment][Expression][Add2][Result] and informs the Expression
17) [Task][MonthlyPayment][Expression][Multiply][Number1][Address] was set to “[Task][MonthlyPayment][Expression][Add2][Result]” when added.
   [Task][MonthlyPayment][Expression][Multiply][Number2][Address] was set to “[Task][LoanAmount]” when added.
   [Task][MonthlyPayment][Expression][Multiply] 70 retrieves the Data and places the result in [Task][MonthlyPayment][Expression][Multiply][Result] and informs the Expression
18) When [Task][MonthlyPayment][Expression] 54 receives the notice that the last Function has updated, it places [Task][MonthlyPayment][Expression][Multiply][Result] into [Task][MonthlyPayment][Expression][Value] 56 and sends a message up to [Task] 42 that [Task][MonthlyPayment] 44 has updated.
19) [Task][MonthlyPayment] 44 sees the update message on its way up to [Task] 42 and retrieves the new value from [Task][MonthlyPayment][Expression][Value] 56 and places it in the user interface Control
20) [Task] 42 receives the update message and removes “[Task][MonthlyPayment]” from the UpdatesExecuting queue and adds it to the UpdateNoticesWaiting queue
21) [Task] 42 checks the UpdatesExecuting queue and sees that it is empty
22) [Task] 42 sends out an update notice to the tree that [Task][MonthlyPayment] has updated
23) No Addresses come back and “[Task][MonthlyPayment]” is removed from the UpdateNoticesWaiting queue
24) Since no more update notices are waiting, execution has completed

From the description above, the lay programmer only added understood Functions that followed an understood sequence and set values in TheTree. Program execution was initiated by one update that caused a sequence of updates to follow. All the Functions were independent and their Data Addresses were immediately available after adding.

Expanding the Value-Centric Program Example

The previous example solved a problem that can be evaluated algebraically. To illustrate more complex programming capability, the previous example will be expanded to solve a problem programmatically that would require a trial-and-error process otherwise.

From the MonthlyPayment equation, it is clear that InterestRate cannot be solved algebraically because it is contained in a Power Function. The Payment Calculator Task will be modified and used to find an InterestRate that satisfies a desired MonthlyPayment, LoanMonths, and LoanAmount. This will require trying an InterestRate and testing the result as to how close it comes to the target MonthlyPayment. This requires program looping.

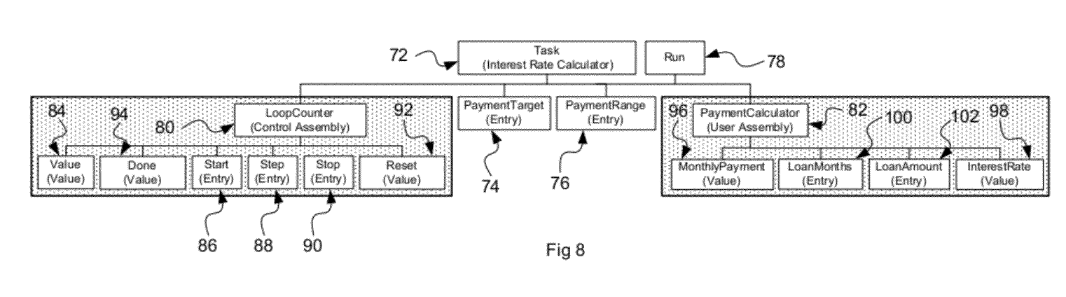

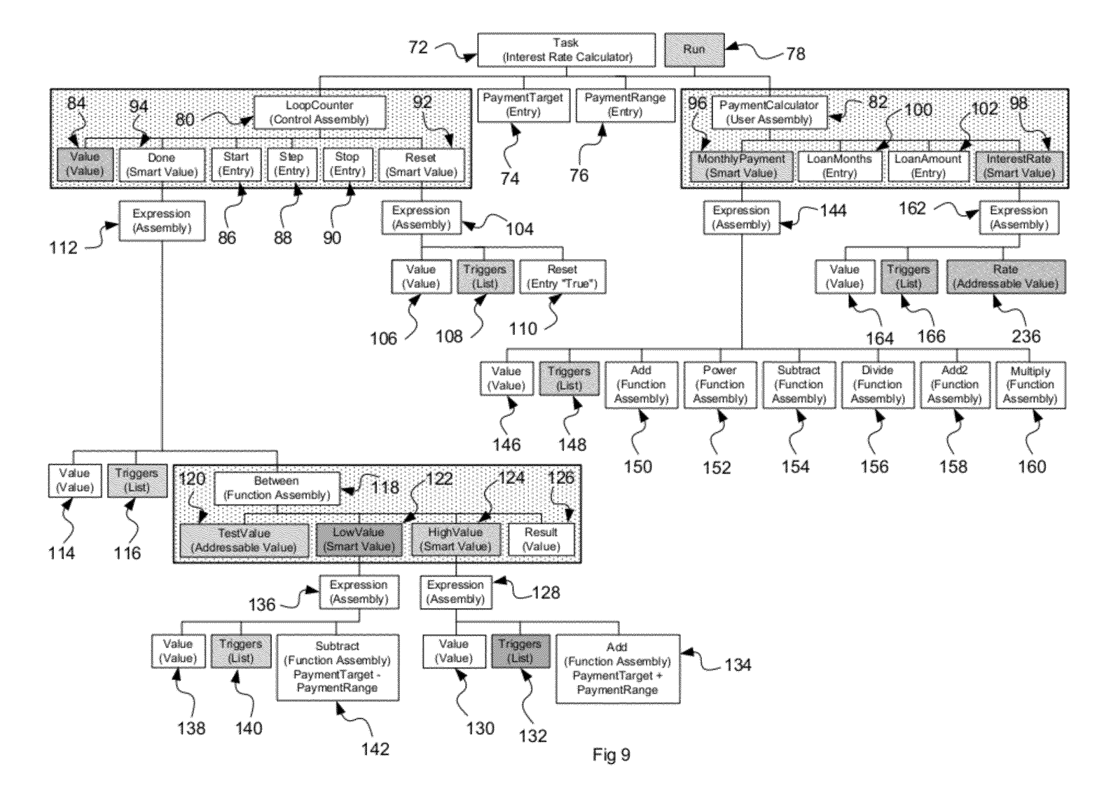

FIG. 8 shows the initial diagram for this example where the Payment Calculator will be put into an Assembly Control so that it is a self-contained Task item. The example needs a Value Control 74 for the target payment and a Value Control 76 for the range of accepted values relative to the target payment. Because this example needs a looping mechanism, a LoopCounter Control is added to the Task. The LoopCounter will be used as the test InterestRate and count from 0.1 to 25 in steps of 0.1. This will cover a range of possible commercial loan rates. The example needs a means of starting the LoopCounter and stopping it if an InterestRate is found that satisfies the PaymentTarget 74 within the PaymentRange 76. Reset 92 and Done 94 in the LoopCounter will be turned into Smart Values to accomplish this. InterestRate 98 has to retrieve the LoopCounter Value 84 to run the PaymentCalculator so it also has to be a Smart Value. MonthlyPayment 96 is a Smart Value from the previous example. FIG. 9 is a diagram of the complete Task Assembly for this program.

The messages that are used to update Smart Values have already been discussed. The diagram is color coded to assist tracking Smart Value updates during the program execution description below.
1) All the Entry values 74, 76, 86, 88, 90, 100, 110, and 102 are filled in by the user
2) The Run button 78 is pressed
3) LowValue 122 in the Between Function updates to PaymentTarget 74−PaymentRange 76 because Run 78 updates
4) HighValue 124 in the Between Function updates to PaymentTarget 74+PaymentRange 76 because LowValue 122 updated
5) Reset 92 in the LoopCounter updates to “True” because HighValue 124 updated
6) LoopCounter sees the Reset 92 update message and loads Start 86 into Value 84 and sets Reset 92 and Done 94 to “False”
7) LoopCounter 80 sends a message that its Value 84 has updated
8) InterestRate 98 updates by retrieving LoopCounter Value 84 as a result of LoopCounter Value 84 updating
9) MonthlyPayment 96 updates because InterestRate 98 updates
10) LoopCounter Done 94 is Triggered by MonthlyPayment 96 updating. The Between Function is run and updates TestValue 120 by retrieving MonthlyPayment 96
11) Between Function evaluates the test and places the result in Result 126 which gets transferred to Done Value 114
12) Done 94 sends an updated message
13) LoopCounter sees the update message and updates by adding Step 88 to Value 84 if Done is “False” which will repeat the loop by triggering InterestRate 98 again.
14) If Done 94 is “True” LoopCounter Value 94 does not update and the program stops. This also happens if LoopCounter Value 84 reaches the Stop value 90.

The information that determines the update sequence and therefore program execution is defined by the aggregate combination of all the individual Expression Trigger Addresses and the Expression updates that follow them. Describing this program is simply the description of the Values, Lists, Tables, and Assemblies in their hierarchical structure. The operating system knows how to put all the supporting intelligence in place during runtime based on the information in the description of TheTree which is also the program description (code as it were). TheTree IS the program. The runtime environment IS TheTree. The Data IS TheTree.

The entire Task can be collapsed into a single text description (Value) and stored in any Value, List, or Table. TheTree or any part of TheTree can be collapsed to a single Text Value. When Data is requested from any branch or leaf on TheTree, what is returned is a Text description of the entire branch. This returned branch can be added to any other tree in the entire Data Environment (TheTree) and would execute in a runtime environment perfectly. This means that programs created can be retrieved, built, and run anywhere in the AOS environment.

Branching in AVCAP

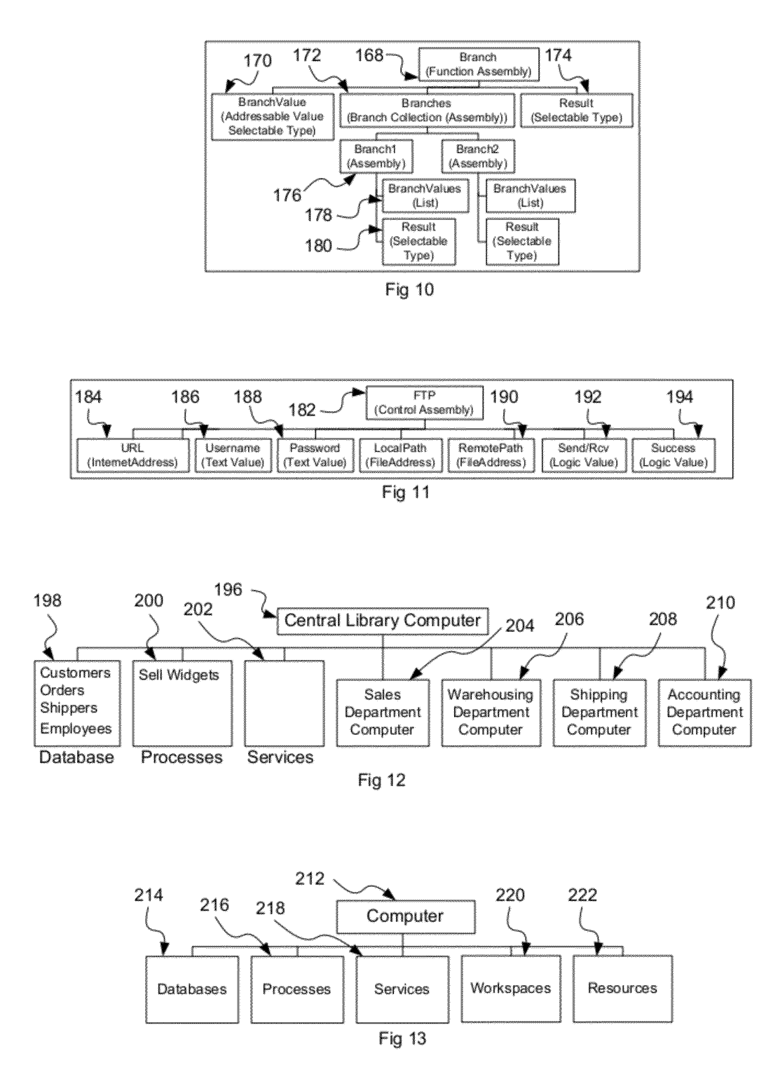

Conditional Branching is an extremely important capability to create complex powerful programs. To provide a uniform approach to branching, one Function type is used for all branching and is shown in FIG. 10. BranchValue 170 is the test value that determines which Branch 176 is executed. At addition time, the user is presented with a dialog to select the Data Type that will be used for BranchValue 170 whether Text, Number, Date, Time, or Logic. The dialog also allows the user to select which Data Type Result 174 should be. Result 174 can be an Assembly for returning complex Data. That Assembly has to match the Result 180 in each Branch in the Collection shown. Once the dialog has the user selections, the description of the appropriate Data-value hierarchy is created and added to TheTree.

Branching in AVCAP is the process of updating the same information in multiple ways.

Because a program is a sequence of Smart Value updates and Smart Values update by their Expressions running, everything programmatic happens within Expressions. Therefore, a Branch Function only appears in an Expression. Branches can be added at will to a Branch Function. BranchValues 178 in every Branch 176 is a list of values that if any one of them match BranchValue 170 it causes that Branch to execute. Branches execute the same way Expressions do and send a message upstream when they are completed. They execute their contained Functions or Tasks sequentially in order of addition. When the last Function or Task in the Branch executes, Result 180 is updated which gets put into Branch Result 174 when completed. In this example, the name of the Function's root branch is “Branch” but could have a user-chosen name that is more meaningful and one that alludes to the Branch Function's purpose in the program.

The Advantages of the Value-Centric Software Architecture

Value-Centricity Reduces the Sources of Error

Every programmer will testify to the fact that the difficulty in software programming lies mostly in the troubleshooting of program execution. Getting the Data and the sequence of function calls free of execution errors can often be a daunting task. By far, the largest and most significant result of approaching software architecture and runtime behavior with the Value-Centric approach is that Autonomy (read-only policy), sequential execution (Value-Centricity), and Data persistence (Architecture) reduces the source of program execution errors to 1:
1) A Smart Value in a sequence cannot update

The sources of this error are 2:
1) A Data source is not available on TheTree
2) A Value is out of range for a given Function that needs it

When a Value cannot update it halts the execution of the program that contains it because Values are updated sequentially and every Value is needed to complete a program. All Value-Centric programs are designed to update Smart Values. Identifying the source of any error is trivial in the Value-Centric environment. The source of the error has a unique address on TheTree even when it is buried within an Expression (a program used to update a Smart Value). It is easy to go to the source of the error and confirm which of the two possible causes produced the error because of persistence (the Value and its Expression are a part of the tree). This puts program troubleshooting easily within the lay person's ability to understand. If a Data source is offline, the present task cannot be completed until it is available again. Every Data source has an address on the tree, getting the source back online eliminates the error. Data Type conformance is strictly enforced in the Value-Centric environment leaving values out of range as the only source of errors concerning Function input Data. For example, everyone with a modicum of public-level education knows that Division by zero results in infinity Infinity is a concept, not a number and would therefore produce an error. In most cases, a lay programmer would fully understand the range of Data that a Function requires.

Value-Centricity Facilitates Data-Type Conformance

Data Type is perhaps the most critical member of metadata (information about Data). In the Value-Centric programming environment, every branch and leaf of TheTree is a Data Type. Some of those Data Types are hierarchical constructs of Data values that combine to provide programmatic capability like the Functions discussed. Other Data Types are simply hierarchical constructs of Data value holders. Custom User Assemblies can be registered with the operating system as a new Data Type so that adding them to interfaces results in the correct Data structure added to TheTree.

The Value-Centric operating system assists in assuring that the correct type of Data is always used. In the Value-Centric environment, the concept of a Librarian has been used which is an assistive tool that helps locate Data in TheTree of the appropriate type. During the programming process, when the user is trying to locate specific Data for any branch or leaf within TheTree, the Librarian will only present to the user parts of TheTree that are the same Data Type or applicable Data Types as the target Data. For instance, Text Values can hold anything in TheTree in collapsed form (text description form). Filling a Text Value would cause the Librarian to show the entire tree for selection because every part of TheTree can be collapsed into a single Text Value. What the Librarian returns is a description of the selected branch or leaf on TheTree. Data values and the address to Data values are considered synonymous but used differently. A Data value is a current piece of information while the address to the same Data value is for retrieving future information. The Librarian knows whether to return Data or Address because Addresses are treated differently than the Data they point to in the Value-Centric environment.

Value-Centricity Assures Data Integrity

Because of the Autonomy designed into AOS (write-protection), all Data on TheTree with the exception of shared, permanent storage mechanisms like files and databases (mechanisms external to AOS), maintains a strict read-only policy. All Data on TheTree is accessible but protected from corruption.

Value-Centricity Prevents Infinite Looping

A Value-Centric program execution is a controlled sequence of Smart Value updates contained within the runtime environment. Sequence always denotes order. This means that the order of Smart Value updates is absolutely determined and implements the informational logic and intelligence for which it was designed. Every Smart Value update follows one or more other Smart Value updates. Specifying this order is trivial. Data value B follows Data value A. Data Value C follows Data value B. Regardless of the complexity or the existence of parallel sequence paths, the entire sequence can be described as the sum total of sequence pairs. An infinite execution loop is a repeated sequence pair before the original sequence has completed. Preventing Infinite Looping is simply the process of rejecting duplicate update pairs during the execution of one given sequence of Smart Value updates and alerting the user when duplicates occur.

Execution loops are an important, useful, and therefore common program structure. All programming languages contain a method for limiting loop execution. Regardless of the syntax, execution of a program loop is accomplished through the use of a controlling value. For-loops use a loop count. While-loops use an arbitrary value test to know when to stop.

Counters have an endpoint that prevents loops that use them from going on endlessly. If Timers are used to create loops they can go on without end if there does not exist a condition to stop the Timer. If the user is in the loop causing every pass to execute then looping is controlled. Timers can be treated as a user action and be set to go off only once. If a Timer is considered a user action then the system can check for any other repeated updates to detect infinite loops. The Timer breaks the loop and looks like the user executed the loop again. This is how a WHILE loop would be constructed. The loop could repeat without falsely detecting the Timer going off again as an infinite loop repeat pair. Timers, Counters, and Buttons are treated as user-proxy updates because they are used to facilitate loops. Making a distinction between user-initiated Smart Value updates and Smart Value updates that are part of a program sequence is the key to facilitating looping while preventing Infinite Looping.

In the Value-Centric operating system, when infinite loops are encountered, they are prevented and the condition is brought to the attention of the user. The information regarding the entire sequence of Smart Value updates is immediately available and points the user to the exact set of updates that are in the infinite loop.

Value-Centricity Eliminates Circular Referencing

Circular Referencing occurs in a programmatic system that evaluates values upon access to those values. AVCAP Expressions only run when Triggered. Therefore, when any Expression is running, all Data in the environment is treated as constant even if that value is in the process of updating. The old Data will be retrieved. This is not a problem since AVCAP executes a logical sequence of independent updates. Knowing the state of any Smart Value is a natural consequence of sequential design.

Value-Centricity Provides Limitless Extensibility

A tree is a boundless structure. It can be added to infinitely. Since programmatic capability is packaged by a defined Data structure that represents a known Data Type and Data Types have system intelligence, then any capability can be designed and packaged ready for program addition as a functional Building Block.

FIG. 11 is an illustrative example of an arbitrary function packaged and designed for the AOS environment. Here, the Function is FTP file transfer. This Control may only show [Send/Rcv] 192 and [Success] 194 in the Interface Control on the Task that contains it. Setting the others might require going into the branch of the Control where the other values would appear for editing. The FTP Control would initiate file transfer whenever the Send/Rcv 192 updates.

Any functionality can be wrapped in a structure of Data and be made available for program addition. Controls go on Tasks while Functions go into Expressions. Providing a growing library of Task Controls and Expression Functions to broaden program capability would be a natural part of the evolutionary path of AOS.

With this extensibility, it is possible to provide a blank Control that has an empty Assembly in its Data structure. This Assembly could hold all the input values as well as output values needed for a custom piece of code. The blank Control could have a text box used for inputting program code in an accepted language. That code could be compiled on demand (if allowed by the operating system development software) and run allowing it to be used in the AOS operating system like any other Control. This would allow trained programmers to write things like printer drivers or any other custom code that could not be written by a lay person and be dropped into any AVCAP program.

Value-Centricity Provides Universal Program/Data Mobility

When a Data structure is “Active” it means that it contains Smart Values somewhere in its structure and exists on TheTree. “Dormant” Data is “Active” Data in collapsed (storage) form. If the Data structure is built within a Task or Expression or Branch, and has applicable Triggers, it will update whenever those Triggers occur. When a Data structure has no Smart Values it is “Passive” and its values are only updated by the user. Regardless of whether a Data structure is Active or Passive, it can be collapsed and stored or moved to another runtime environment and since all Addressing is absolute, Active Data will update correctly regardless of where it is moved in the same tree. Because all Data within TheTree can be collapsed to Text values, anything can be stored in Values, Lists, and Tables. For example, a List can contain a number of Tasks in collapsed form. Any of these Tasks can be selected and opened at will. This is true of any Data Type except Libraries and Computers in their entirety. Workspaces can be stored in Tables or run anywhere on TheTree. Entire Processes and every piece of Data they used can be collapsed and stored in a Table for records keeping. Tracking Process problems becomes a simple endeavor when all the Data that was used to complete that Process is available for review.

Value-Centricity Enables Distributed Applications

Universal Program/Data Mobility opens the door to Distributed Applications. A Distributed Application is a program that is comprised of a sequence of Tasks. These Tasks are run independently on different computers by different users. This is exactly the model of most business processes. An example will illustrate this important capability.

All businesses are a process: a repeated procedure that performs one or more functions. This looks suspiciously like a Function-Centric program and the truth is that every process is a program and every program is a process. As stated, the two words are defined and used synonymously. The difference between a business process and a software program is that a business uses information and tangible resources like people and physical resources such as buildings and office furniture to execute. A software program can only use and manipulate information. An interesting point to note about businesses is that most of them are organized in a hierarchy.

In a business, processes are executed by numerous persons on numerous computers in a sequenced fashion. This is exactly a Function-Centric model. Each person in an organization has specific functionality. That functionality is used by different parts of the system. If you view a business process as a computer program where individuals are the sub-functions then the business's databases or records of whatever type serve as its Persisted Values. Individual applications like Excel or Photoshop serve as tools used to complete the functionality that an employee provides.

To illustrate a Distributed Application, we will take a software approach to a business process and examine how it directly parallels a Function-Centric programming model but is programmed and executed using a Value-Centric operating system and programming methodology.

A Value-Centric Business Information Architecture Example

Most businesses today are comprised of a number of employees that all have access to a computer that is on a local network. The computers on a contemporary network do not have to be connected in a hierarchical fashion but they can be. For the sake of discussion, we will assume that all the computers within a small business are all one the same network and can communicate to each other.

The most common model used today for computing in a multiple-computer architecture is that of the client/server relationship where informational resources are shared throughout an organization. Servers provide those resources on demand to the clients and this is the basic model that AOS uses. AOS terms these Servers as Libraries to break away from the stigma of some perceived highly-technical terms to the lay public. Libraries provide to the AOS environment three fundamental sources of information:
1) Databases—sets of Tables that pertain to a specific subject matter
2) Services—access to Data that clients cannot obtain themselves or has been prepared in some specialized manner
3) Processes—Distributed Applications

All of these sources appear as Data-value hierarchies on TheTree. Databases are straightforward and used all over the world and constitute the long-term information storage for an organization. Services might be something like information on the interne that the Library can retrieve but client computers cannot for security reasons. Processes are simply programs that are available to the entire AOS environment.

In AOS, Processes are programs that are comprised of individual Tasks that client computers execute in their own runtime environment. A Task is simply another name for a program and is created by the users in the organization using AOS programming methods. A new Process Task has two empty Assemblies that are attached to it and therefore a part of this type of Task's Data value hierarchy. These Assemblies are System Data Types (AOS components) which means they have programmatic intelligence written by the AOS programmers that manage that hierarchy. Libraries are Data value hierarchies as are Computers and every other Data Type within AOS. The Assemblies attached to the Process Task hierarchy are called Inputs and Outputs. A program can only execute when it has the information that it needs and not before. This simple truth is the foundation of sequencing a distributed program made up of Tasks that are executed on different computers. When a Process Task has all of its Input information satisfied, it is ready to execute regardless of when it is actually executed. Processes publish (make available to the AOS environment) their Tasks when they are ready to execute. Whenever a program completes, its results are available. When a Task is completed (all of its Outputs have been satisfied), it is returned to the Process where its Output Assembly Data values are available to uncompleted Tasks in the Process.

In AOS, computers connect in a hierarchical fashion. Libraries allow client computers to connect to them so that they can communicate. One Library (Central Library) serves as the root of TheTree and allows other Libraries and client computers to connect to it. All computers whether they are Libraries or Computers have a unique path on TheTree and are tree branches in the Data-value hierarchy. Therefore, all Data values in the hierarchy (functional organization) are uniquely addressable and available to the entire AOS environment.

As an illustrative example of an AOS distributed program, we will construct the AOS Data-value hierarchy for a fictitious company that sells widgets. This is the primary Process for this company (means of achieving a profit). FIG. 12 is a diagram of the computer connectivity used in this example. In FIG. 12 we can see a computer serving as the Central Library 196 with its three types of sources of information on TheTree. There is a single Database 198 with four Tables and one Process 200 defined. A partial Computer Data-value hierarchy is shown in FIG. 13. Computers in the AOS environment can also contain Databases 214, Processes 216, and Services 218 that are on TheTree and therefore globally available. Workspaces 220 are Tasks (programs) that manage the Data pertaining to a particular workspace. Resources 222 provide a storage place for user-created Data-value hierarchies. These might be Expressions, Tasks, Task Controls or custom User Data Assemblies.

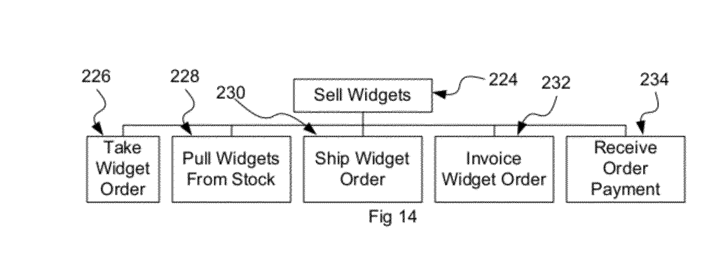

FIG. 14 is a partial diagram of the Sell Widgets Process Data-value hierarchy. The Sell Widgets Process contains five Tasks which are programs executed on the client Computers to complete the end-to-end Process.

In our example, The Sales Department Computer 204 has a Workspace that contains a Task Control that retrieves a copy of the description of the Take Widget Order Task Data-value hierarchy and adds that hierarchy to TheTree when the Task is opened. This Task is the first in the sequence of Tasks to run for this Process. When a sales person is ready to take an order, the Take Widget Task 226 is opened on the Sales Department Computer 204 Workspace (added to TheTree). Within that Task will most likely be a Table of products as well as a Table for the ordered items as well as a Table for existing Customers. There would also be Values for Customer information in case the order is from a new customer. All of the Tables on this Task would get their Data from requests sent to the Central Library Database 198 (only 1 in this example) when the Task opens (“Task Running” Value updated in the Task Data-value hierarchy). When the order is completed, the user pushes a button on the Task. Every Process Task has a value that is its return address to the Process that owns it. The Task describes its Data-value hierarchy and sends that description back to the Process where the copy of the Task in the Process is updated with the completed Values. When a Process Task updates, the Process programmatic intelligence informs the entire branch of TheTree (Sell Widgets Process) of all the Data-values that got updated. Other Task Input Data-values that are waiting on these updates will in turn update themselves. A Process Task examines all of its Input Data-values when any of them update and determines if all of them have been filled. If they are all filled, the Process Task informs the Process that it is ready for execution where the Process adds that Task to a list of ready Tasks of that name. Since Processes are programs that are repeated, there must be a means of discerning one instance of the Process to the next. This is handled by adding an instance identifier to the Process name as well as all of its Task names. In our example we'll use Sell Widgets 001 as the name for this instance of the Sell Widgets Process. When Take Widget Order 001 updates, Pull Widgets From Stock 001 will have the information it needs to execute (Table of order items to pull from stock). The Process adds “Pull Widgets From Stock 001” to a Pull Widgets From Stock Ready text list.

The Warehousing Department Computer 206 has a Workspace that contains a List that shows the names of the Pull Widgets From Stock 228 instances that are ready for execution. This Workspace also has a Timer set to go off every 5 minutes. When the Timer updates (goes off), the List will retrieve its Data (update). The Workspace also has a Task Control that retrieves a Task Data-value hierarchy at a specific Address on TheTree and opens that Task onto TheTree whenever its Address updates. The user in the warehouse highlights “Pull Widgets From Warehouse 001” which causes the Task's Address to be updated whereby that Task's Data-value hierarchy is retrieved and added to TheTree for execution. Once the widgets are pulled from stock and the Task's information updated by the user, the Task is completed where it returns to the Sell Widgets Process. As a result of Pull Widgets From Stock 001 updating, Ship Widgets Order 001 has all the information it needs and is added to that Task's Ready list.

The Shipping Department Computer's 208 Data-value hierarchy is exactly the same as the Warehousing Department Computer 206. It's List of ready Tasks is addressed to Ship Widget Order Ready List. It executes a selected Task the same way as above. When Ship Widget Order 001 is complete, it is returned to the Sell Widgets Process where “Invoice Widget Order 001 is added to that Task's ready list because it has all the Data it needs to execute.

The Accounting Department Computer 210 Workspace has two Lists. One for Invoice Widget Order Ready and another for Receive Order Payment Ready. Invoice Widget Order 001 is ready when shipping has completed its Task. When Invoice Widget Order 001 is completed, Receive Payment Order 001 is ready. When payment for the order comes in, Receive Order Payment 001 is completed which completes Sell Widgets 001 where its Data-value hierarchy is stored on file.

From the provided example, if the Sell Widgets Process (program) is viewed from a Function-Centric approach, then the five Tasks that make up the Sell Widgets Process are Functions. In a Function-Centric program, sub-functions are executed in a sequence determined by sub-functions calling each other in a programmatic order. In the Value-Centric approach, the Tasks act as “Active” Data-value holders that are pulled into a Computer and updated. Their sequence of updating is determined by the update order of the information that the Tasks need before they can execute. The Sell Widgets Process (program) was executed on different computers at different times and is therefore is in essence a “Distributed Application”.

Since the Computers in this example don't have to be on the same local network because Libraries and Computers can connect over the interne, one can immediately see the possibilities for distributed-location organizations and inter-organization collaboration on the execution of any given Process (program).

Describing TheTree

As stated previously, TheTree when built is:
The Data environment
The Runtime environment
The Program

Collapsing any part of TheTree into a single text value for storage or moving requires a language to describe TheTree.

TheTree is described through an AOS text-based language called HiMl (Hierarchical Markup Language). To textually describe a hierarchical structure requires a means of denoting the beginning and the end of the description of individual entities in the hierarchy. These “markers” must be infallibly discernable in a text string between the combination of characters that comprise the markers and the occurrence of any other character combinations. Since there are a limited number of non-typical text characters on the English computer keyboard, some of the characters used will be in common with other markup languages. Markup languages replace parentheses (a functional concept in mathematics specifically Algebra) with other keyboard characters that are not as common as parenthesis. The specific characters used to create markers are arbitrary.

To describe Data for use in a computing environment, there is more information required than just the Data itself. Information about Data is typically called metadata. Data Type is metadata and was discussed previously but there is much more information that can be used. Data Name is an important attribute of Data. Humans use Data Name as an identifier of specific pieces of Data. The computer does not use names as a means of identifying specific pieces of Data. The computer uses location in memory for its means of Data identification. Therefore, Data Name is an attribute that accommodates human usage of Data. Data Name information most often conveys the functional purpose of the information. The purpose of using Data named “Customer Name” is easily understood. Below is the list of the information that HiMl uses to describe Data.
Name
Type—identifier for a system-known type such as Text and Numbers or Dates
Form—Value, List, Table, Assembly
Address or Data—delineation between Data and an Address to Data of the same Type
Data size limitation—information about the source of the Data to facilitate the storage of return Data when Data storage mechanisms are used. All Data storage mechanisms like databases have finite limitations on the size of Data they can store.
Display Settings—colors, fonts, position, rows to display, visible, editable
Permissions Settings—Read, Edit, Design

Beginning and end markers in HiMl contain the above information minus Display and Permissions Settings. These Settings are contained within every branch or leaf on TheTree. Within any given pair of markers there will exist either Data (leaf) or a collection of HiMl descriptions of Data hierarchies (branch Assemblies). If the contents of a pair of markers is a collection of Data hierarchies, each of these Data Hierarchies describes a tree branch. TheTree is grown by adding a branch and giving that branch its description. If a pair of markers contains Data, that Data is stored at the current location within TheTree. The process of building TheTree through the use of HiMl markers is enumerated below.
1) A branch of TheTree (root is first branch) is instantiated
2) The branch of TheTree is supplied with its HiMl-description text
3) The outside beginning and end markers are retrieved from the description
4) Metadata is retrieved from the markers
5) Marker contents is retrieved from the description
6) Markers are removed from the description
7) Description is HiMl collection or Data—if Data then store—stop
8) A new tree branch is instantiated for every HiMl description in the collection and provided with its description—repeat

The HiMl description of TheTree is in essence distributed across TheTree. Each branch consumes its part of the original HiMl text description.

To create and store a HiMl description of TheTree, a command is sent to the root of TheTree to report its description. Every tree branch knows how to describe itself in HiMl. Each tree branch responds to the command by creating text information about its contents and bracketing that text with the correct beginning and end markers. The branch then passes that text information (HiMl description) to its parent branch. The parent branch receives the HiMl description and adds that description to its collection. When the collection is complete, it packages its own description and passes that description up to its parent. The process repeats until the root branch's collection is complete. The root branch then describes itself with the correct markers and passes the entire HiMl description of TheTree to the commanding entity. Because every branch within a tree is a tree itself, any branch of TheTree can be individually commanded to describe itself. This is the primary process for Data retrieval in the Value-Centric programming environment. Data retrieval from Tables is accomplished through an SQL-based request. An intuitive tool assists a lay person to logically assemble an SQL statement.

Conclusions, Ramifications, and Scope

If all High School graduates were able to create powerful programs with almost no training and those programs could be shared in a Distributed Application, the possibilities are literally endless. Businesses could program the information for every process that runs that business. They could create new programs that collect and analyze Data to improve the business's performance. They could create programs that monitor real-time business process performance. They could share their processes with other companies to automate interaction between organizations. The implication of adding the commonly educated public as a creative source of programmatic intelligence goes beyond what the imagination can envision.

Scope

Value-Centric program execution is a sequence of Smart Value updates. Each of these Smart Values are calculated differently based on their included Functions. Therefore, Value-Centricity is ideal for a relatively small number of Smart Values that are all unique in their evaluation. In contrast, graphics programs have a large number of values that are all evaluated in similar ways. For instance, if a picture is being modified as to its brightness, every pixel will go through an algorithm that modifies its brightness. In a Value-Centric program, every pixel would have to have its own Expression and those Expressions would be identical. This is impractical for the thousands of pixels in most pictures. The same would hold true for modifying a sound: many similarly manipulated values.

All programs can be organized into two categories:
1) Data Management Applications—small number of individual values of different types evaluated differently (approximately 100 or less per Task)
2) Specialized Applications—applications that manipulate large numbers of values similarly or are calculation intensive

Data Management Applications are the types of programs that AVCAP is perfectly suited for. Programs that can be created by the lay public. Data Management Applications retrieve, use, and manipulate the common types of Data found in business processes that are typically stored in Database tables:
Text
Numbers
Dates and Times
Logic
Binary (pictures, sounds, files)

The present invention is the first known solution in the information domain that provides an environment and programming methodology that can utilize the functionality of individual functional components in a computer-assisted organization such as a business in the same way that a computer program makes use of sub-functions and one that can be programmed and improved by the individuals that participate in the business process who have little or no training in information technology but represent the best practical source for process improvement and innovation.

What is claimed:

1) a system for executing a software program, said software program comprised of the description of a hierarchical structure of data values whereby some of said data values (henceforth referred to as “smart values”) are themselves data-value hierarchies that contain the information that determines their individual equivalency and update timing, said software program execution being characterized by a controlled and repeatable sequence of smart value updates within said software program's hierarchical structure of data values:

2) The system of claim 1 wherein each of said Smart Values:
is defined by a Data-value hierarchy in the same manner as said software program of claim 1;
evaluates its Data-value equivalency by executing a defined sequence of Data-value updates within its branch of said Data-value hierarchy of claim 1;
contains a collection of identifiers of Data values within said hierarchical structure of Data values of claim 1 that define its position(s) within said controlled and repeatable sequence of Smart Value updates of claim 1,
the aggregate combination of all said collection of identifiers defining said controlled and repeatable sequence of Smart Value updates that constitute said software program execution of claim 1.

3) A method for creating and/or editing said software program of claim 1 characterized by the addition of Data-value hierarchies to said hierarchical structure of Data values of claim 1and/or the deletion of Data-value hierarchies from said hierarchical structure of Data values of claim 1.
